(19) United States
(12) Patent Application Publication
(10) Pub. No.: US 2006/0031456 A1
(43) Pub. Date: Feb. 9, 2006

(54) Method and apparatus for transmitting data between devices in a web networking environment

(76) Inventor: Marcos Della, Scotts Valley, CA (US)

Correspondence Address: HAVERSTOCK & OWENS LLP, 162 NORTH WOLFE ROAD, SUNNYVALE, CA, 94086, US

(21) Appl. No.: 09/920,083

(22) Filed: Jul. 31, 2001

Related U.S. Application Data
(60) Provisional application No. 60/221,818, filed on Jul. 31, 2000.

(51) Int. Cl. G06F 15/173

(52) U.S. Cl. 709/224; 709/225

(57) ABSTRACT

The web support system utilizes a pre-configured wire harness that interconnects a file server, web servers, application servers and a data base. The pre-configured wire harness provides at least a portion of the system bus network, over which data is transmitted between the system components and the web. The pre-configured wire harness preferably includes a switch that switches the connectivities between web serves within the system to ensure redundancy of critical system components. The system preferably auto-programs each of the components according to their connectivities to the pre-configured wire harness from the file server and provides for discretionary data a transmissions between the web and the system. In accordance with an embodiment of the instant invention, the system is equipped with a central control unit which monitors system components and provides a warning if a system component is in jeopardy of malfunctioning.

### RELATED APPLICATION(S)

This Patent Application claims priority under 35 U.S.C. 119 (e) of the co-pending U.S. Provisional Patent Application, Ser. No. 60/221,818, filed Jul. 31, 2000, and entitled “METHOD AND APPARATUS FOR TRANSMITTING DATA BETWEEN DEVICES IN A WEB NETWORKING ENVIRONMENT”. The Provisional Patent Application, Ser. No. 60/221,818, filed Jul. 31, 2000, and entitled “METHOD AND APPARATUS FOR TRANSMITTING DATA BETWEEN DEVICES IN A WEB NETWORKING ENVIRONMENT” is also hereby incorporated by reference.

### FIELD OF THE INVENTION

The present invention relates to an architecture, a system for and a method of transferring data between web devices in a web network environment and the general internet population. More specifically, this invention relates to an efficient, adaptable and scalable architecture, system for and method of transferring data between web devices in a web network environment and the general internet population.

### BACKGROUND OF THE INVENTION

The internet provides a general public transport medium to support several user protocols such as e-mail, FTP and HTTP. With the internet, computers can share information throughout the world and in space being only limited by the ability to establish a point of connection with the internet. The internet provides reliable, inexpensive, high speed data transmissions for transacting business in business-to-consumer or business-to-business relationships world wide. Because of the flexibility and the ease with which information is transmitted over the internet, e-commerce and the internet is changing the fundamental way that business is conducted.

Using a personal computer, and the appropriate user protocols, customers log into web sites and accesses web pages or HTML files that are hosted at remote web servers. Web server devices are usually individual machines that support each of the internet protocols that in turn provide the data to consumers through their personal computers. The customers can access and receive information about a business or an organization, interact with the web pages or HTML files and provide customer information to the organization or business.

The systems hardware and software that drives and supports a web site after it is physical connected to the internet is referred to, herein, as a web support system. Typically, each web support system is tailored to suit the particular needs of the organization or business. For example, a web support system which receives and collects tax information requires the ability retrieve and store large amounts of data. Such a system will be data base and data storage intensive and will, therefore, typically have several data base/storage components or devices. On the other hand, a web support systems which provides customers with interactive games to promote products is application intensive and will typically require several application components or devices. Regardless of the particular needs of the organization or business, each web support system is custom designed and custom built, with each of the system components or devices being wired to a system bus and individually programmed.

### SUMMARY OF THE INVENTION

According to the current invention, a web support system is constructed by providing a pre-configured, layered design that interconnects individual system components in a predetermined position relative to one another and provides at least a portion of the system bus for the transmission of data between the components. The pre-positioning of components is customized to meet the needs of a business or organization, but may also be standardized to meet several application needs. The layered design is preferably configured to be versatile enough to provide the connectivities for components within a systems having a variety of system complexities and configurations. For example, the layered design is configured with dormant or spare positions that allow for the integration of additional components or devices into the system as the needs of the business or organization change, expand or evolve. The layered design preferably provides positions for a plurality of web servers, a file server, a data base device, and at least one application server.

The system of the current invention provides for the ability to program each of the system components with personalities required to perform their particular function based on their respective positioning to a pre-built harness. In accordance with the invention, the file server is programmed with knowledge of the layered design, system architecture and component positioning on the wire harness and stores the configuration files required to program each of the system components. The file server auto-programs and auto-updates each of the components according to their individual function and relative positioning to one another on the pre-configured wire harness. In the event that one of the system components needs to be replaced due to a malfunction, the file server will automatically program the new replacement component to perform the function of the replaced component. This can greatly reduce the cost of maintenance for the web support system because an organization or a business can simply unplug the defective component from the wire harness and replace it with a new component without calling a technician to install and program the replacement component.

The pre-configured wire harness has several other advantages including reducing or eliminating confusing agglomerations of wires typically associated with web support systems and provides a simple and efficient way to duplicate a preexisting web support system. For example, in the event that a business or an organization wants to relocate the physical location of their web support system, then a duplicate pre-configured harness is provided along with a duplicate file server device containing duplicate configuration files for each of the components in the master web support system. The auto-programming features of the file server device, along with its knowledge of the system architecture allows each of the new components in the duplicate system to be auto-configured and duplicate the functionality of corresponding components in the master system. Thus, a business or an organization never needs to shut down, stop traffic or reduce traffic to their web site while construction of a new system is underway.

According to the preferred method of the instant invention, the configuration files that are used to program each of the system components with their appropriate personalities are down loaded to the file server from a remote location. Thus, with the installation of an entirely new web support system, the components of the new system are first connected to the bus through the pre-configured wire harness. The configuration files are then down-loaded to the file server from the remote location. Then the file server auto programs all of the other system components with their respective personalities. The entire system is then initialized to support the web site without requiring any of the individual components be programmed by an on-site technician. Further, by remote downloading of the configuration files and system shared software to the file server, the system is continuously updated from the remote location with new and improved configuration files and software. In this way, the file server provides the auto-programming intelligence link for each of the individual components within the system. Preferably, after the system is initialized each component periodically queries the file server to initiate the installation or updated configuration files, programs, software or files.

According to an alternative embodiment of the invention, the pre-configured wire harness is configured with a switching means to switch the connectivities between system components. Preferably, the switching means is provided to switch the connectivities between a web server and an application server. In the event that a critical server malfunctions, the server can be switched out and effectively replaced with a functioning and less critical server that is already available within the system. After switching the defective server with the replacement server, the replacement server is auto-programmed to operate according to its new function. Because web support systems are typically provided with duplicate servers of each type, switching out of a server device, as described above, does not leave the web support system void of any particular functionality, but rather effectively ensures that critical functions of the system are always duplicated and, therefore, reduces the possibility of a critical systems failure.

As a further improvement over currently available web support systems, the architecture of the current invention preferably provides for at least two transmission pathways between the web support system and the internet. One of the pathways is a non-restrictive transmission pathway between the web support system and the internet and the second data transmission pathway includes a fire wall device between the web support system and the internet. According to current invention, the system discerns between nonsensitive data and sensitive data. The nonsensitive data is transmitted between the internet and the web support system through the non-restrictive data transmission pathway and the sensitive data is transmitted through the data transmission pathway that includes a fire wall device between the web support system and the internet. The web architecture of the instant invention, provides for discretionary data transmissions between the internet and the web support systems at the system level and provides for the ability to transmit high volume data between the internet and the web support system more efficiently.

In yet another embodiment of the present invention, the web support system includes a central control unit. The central control unit is in connected to individual system components or devices. This central control unit can co-exist on the file server to provide multiple functionality within the web support system. The central control unit monitors the physical condition of each of the connected components or devices. Preferably, the central control unit collects and stores data regarding the physical condition of each of the connected components over time. For example, the control unit monitors each system component for temperature variability. In the event that one of the components malfunctions, the data can be analyzed to discern if the cause of the malfunction was related to a fluctuation in temperature. The central control unit is also configured to have alert function. In the event that the functionality of a component or device within the system is in jeopardy, either due to an unauthorized intrusive action or because of changes in environmental conditions, an alarm is initiated on site or at a remote location.

### BRIEF DESCRIPTION OF THE DRAWINGS

FIG. 1 illustrates a prior art two-tier web support system architecture.

FIG. 2 illustrates a prior art three-tier web support system architecture.

FIG. 3 illustrates three-tier web support system architecture, in accordance with the current invention.

FIG. 4 illustrates a block flow diagram for building the web support system, in accordance with the current invention.

FIG. 5 illustrates a block flow diagram for exchanging or replacing a server device within the web support system, in accordance with the current invention..

FIG. 6 illustrates schematic of a three-tier web support system architecture with a switching harness for exchanging connectivities of servers within the system.

FIG. 7 illustrates three-tier web support system architecture with a network switch to be managed by a central control management function, in accordance with an embodiment of the current invention.

### DETAILED DESCRIPTION OF A PREFERRED EMBODIMENT

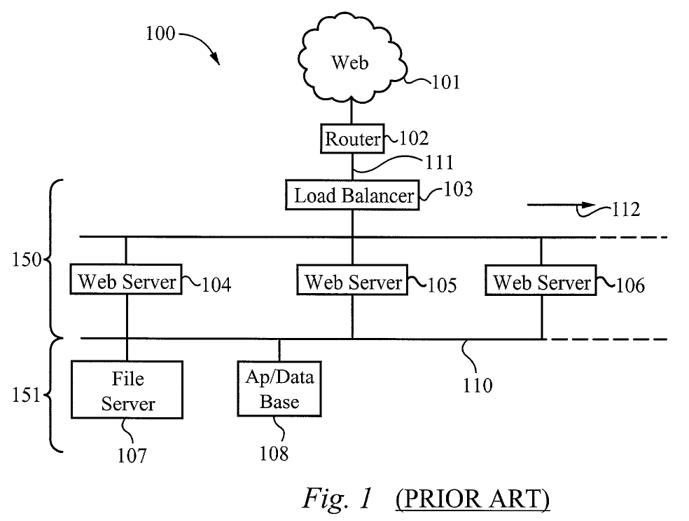

FIG. 1 illustrates a two-tier web-bases system 100 according to a prior art design. The architecture has a web interface tier 150 and an application/data base tier 151. The web or the internet 101 is connected to the system 100 through a router device or a firewall device 102. The router device 102 provides for data transmission security over the entire system. The router device 102 reads each data packet, or a portion thereof, before it is transmitted between the web 101 and the system 100. The router 102 checks for the proper authorization code or an authorized address and only allows those data packets with a proper authorization code or address to pass between the web 101 and the system 100.

The web servers units 104, 105, and 106 are continuously connected to the web 101 and contain web pages or HTML files that are be viewed from a browser program on a remote computer device (not shown). Between the router 102 and the web servers 104, 105, and 106, there is a load balancer 103 which coordinates data transfers or directs traffic between customers accessing web pages or HTML files on the individual web servers 104, 105, and 106.

Still referring to the FIG. 1, within the application/data base tier 151 there is a file server 107 and at least one application/data base device 108. The file server 107 stores software that is shared between each component of the system 100; in particular the software shared between the application/data base 108 and the web servers 104, 105, and 106. The file server 107 shares software with the other system components over a system bus 110 or a local area network (LAN) which provides the physical point-to-point connections between each system components. The application/data base device 108 provides the system 100 with raw computing power and storage capacity for storing the data required to achieve the intended results of the system 100.

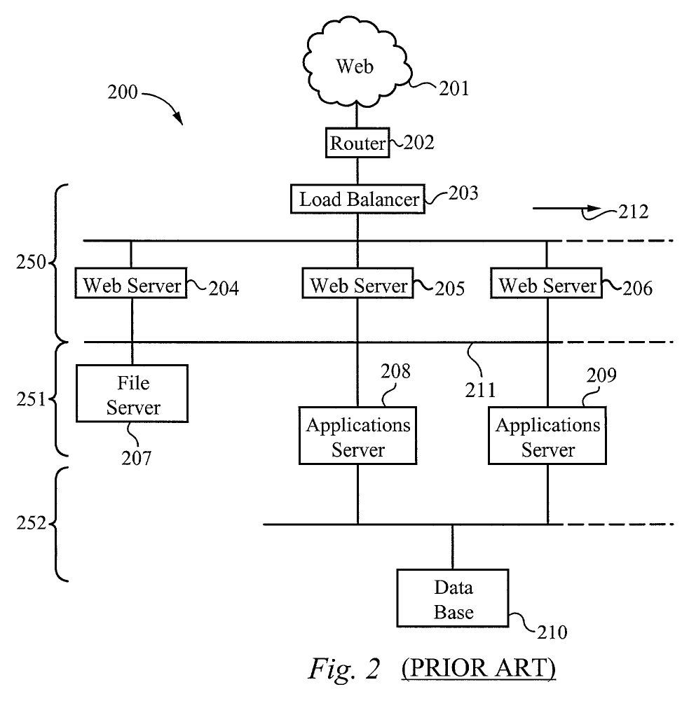

FIG. 2 illustrates a three-tier web-based system 200 according to a prior art design. The web interface tier 250 of the system 200 is identical, or similar, to the web interface tier 150 that is shown in the FIG. 1. The web or the internet 201 is connected to the system 200 through a router device or a firewall device 202. The router device 202 provides the same security functionality as that of the router device 101 that is shown in the FIG. 1 and described above; namely, the device 201 prevents the transmission of unauthorized data between the web 201 and the system 200.

The web servers 204, 205, and 206 are again continuously connected to the web 201 and contain web pages or HTML files that can be viewed from a browser on a remote computer device (not shown). As with the web system 100 illustrated in the FIG. 1, the system 200 has a load balancer 203 positioned between the router 202 and the web servers 204, 205, and 206, which coordinates data transfers or directs traffic between customers accessing web pages or HTML files at the individual web servers 204, 205, and 206.

Still referring to the FIG. 2, the three-tier system 200 has an application tier 251 with application servers 208 and 209. The application tier 251 is configured with any number of application servers suitable for the intended purpose. The system 200 also has a data base tier 252 with at least one data base device 210 which can be configured with any number of data base devices suitable for the intended use of the system 200.

Regardless of whether a web support system has the two-tier architecture, as shown in the FIG. 1, or the three-tier architecture, as shown in the FIG. 2, the ability of such systems to support high volumes of data transmissions is limited by the ability of the router device or fire wall device to process, to decode and authorize the data transmissions between the servers and the web. The architecture of the current invention seeks to reduce the restriction of data flow between the web support system and the web by providing at least one additional data transmission route between the support system and the web.

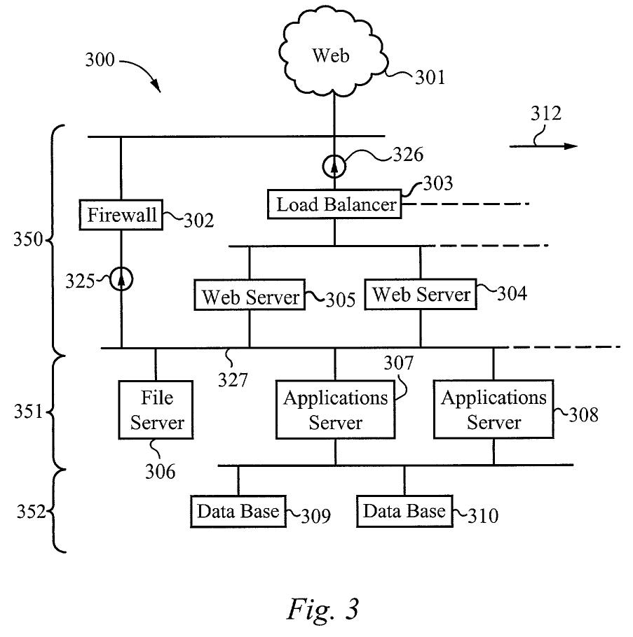

FIG. 3 illustrates a three-tier system architecture 300 according to the preferred embodiment of the current invention. It will be clear from the ensuing description, that architecture described is also compatible with a two-tier architecture or any other number of system architectures that are known in the art. The architecture 300 has web interface tier 350 with web servers 304 and 305. The web interface tier 350 is connected to the web 301 at the systems level through a bus 327 having an in-line router device or a firewall device 302 for providing a restricted data transmission pathway 325 between the system 300 and the web 301. The restricted data transmission pathway 325 is used for transmitting potentially sensitive data between the system 300 and the web 301. The system 300 is also connected to the internet 301 by a non-restricted transmission pathway 326. The non-restricted pathway 326 is for transmitting non-sensitive data between the system 300 and the web 301. Preferably, the system 300 has a load balancer 303 which coordinates data transmissions or directs traffic between customers accessing web pages or HTML files stored on the web servers 304-305.

Still referring to FIG. 3, the system 300 also has an application tier 351 with application servers 307-308 and a file server 306. The data base tier has data base devices 309-310 which provide the data storage and data management required for the system 300. The system 300 that is illustrated in the FIG. 3, is intended to be exemplary only. The “multi-path data transmission architecture” (MPDTA) of the current invention can be practiced with web support systems configured for any number of web servers, application servers and data base devices.

Still referring to FIG. 3, the system 300 preferably determines whether or not data is potentially sensitive at the systems level. If the data is determined to be potentially sensitive, the system 300 routes the data over the bus 327 through the data transmission path 325 and through the router device 302. If the system 300 determines that the data is non-sensitive, then the system 300 routes data over the bus 327 through the non-restricted data path 326.

By providing discretionary data transmissions at the systems level, the amount of data that is required to be transmitted through the router 302 is greatly reduced and the system 300 is capable of supporting higher volumes of data transmission than a similar system with a single data transmission pathway between the system and the web 301. As a result of the increase system efficiency provided by the multi-path data transmissions architecture of the instant invention, the system 300 can support additional components integrated into the system in the direction 312 without requiring an additional router device or without splitting the devices between multiple web addresses.

Web support systems, such as those described above, are typically custom wired, custom installed and each of the system components, including the web servers and the application servers, are individually programmed by an “on site” technician. This process is both costly and time consuming. Further, web support systems that are constructed by this method result in agglomerations of wires connecting the system components. The wiring is both difficult to maintain and difficult to repair in the event of a malfunction. Thus the system 300, is preferably provided with a pre-configured wire harness (not shown) that is designed to provide the connectivities for each of the system components including the web servers 304-305, the application servers 307-308, the file server 306, and the data base devices 309-310. The pre-configured wire harness provides a map for the system connections of each of the components 304-310. The pre-configured wire harness also provides for at least of portion of the network bus 327 through which data is shared between the components 304-310 and transmitted between the system 300 and the web 301. The pre-configured wire harness of the current invention reduces the amount of wiring required to connect the components, provides a standard for interconnecting each component 304-310 of the system 300 and allows the connections between components 304-310 of the system 300 to be readily traced and repaired in the event of a malfunction.

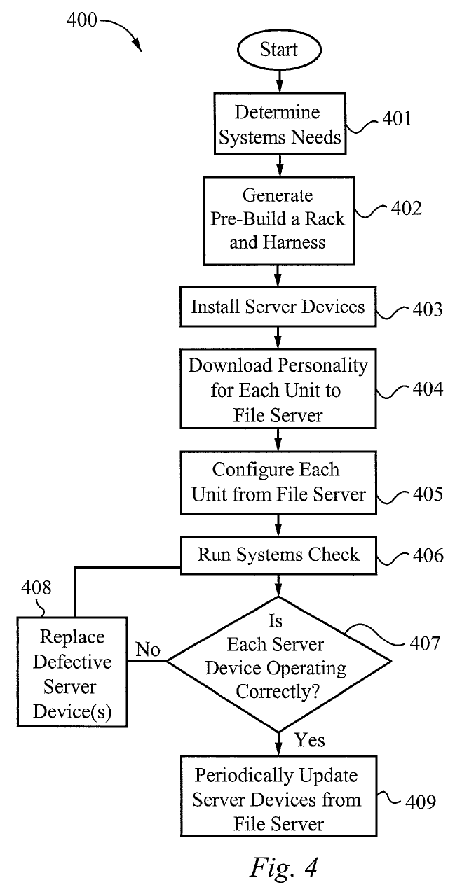

FIG. 4 illustrates a block flow diagram 400 for constructing a web support system according to the method of the current invention. In the step 401, the system needs are determined. System needs include the number/type of web servers, the number/type of application servers, and the number/type of data base devices that are needed to support the web site. After the systems needs are determined in the step 401, then in the step 402 a wire harness is configured to support the components and to provide the connectivities for all of the components. The wiring harness is preferably installed into a rack which provides the physical support for some, or all, of the system components. The support rack, the wire harness and the components are then either sent to the preferred installation location where they are assembled in the step 403. Alternatively, the components are assembled in step 403 and then sent to the preferred installation location. The step 403 of assembling the system is accomplished by connecting each of the components to their respective predetermined connectivities within the pre-configured wire harness and by providing a connection to the web.

In the step 404, configuration files are down-loaded to the file server. The configuration files are then used in the step 405 to program each of the system components with a functional personality that is required for the device to perform an assigned function, as determined in the step 401. The step 404 of downloading the configuration files is preferably accomplished by down-loading the configuration files to the file server after the assembly step 403. However, it is considered to be within the scope of the invention that the configuration files are down-loaded to the file server prior to the assembly of the system in the step 403.

In the step 405, the file server programs each of the system components with the appropriate configuration file. The file server determines which configuration file is appropriate for each component based on programmed knowledge of the connectivities of the component to the pre-configured wire harness, by the serial number code of each component, a logical address on the system bus or a combination thereof. The installation of the configuration files or the programming of each of the system components in the step 405, is initiated either by the file server or by the components themselves. Preferably, after the components are configured in the step 405, then in the step 406 the system is initialized and tested to ensure that the system and all of the individual components are functioning properly. If it is determined that there is a malfunction or that all the proper connections have not been made in the step 407, then in the step 408 the malfunctioning component or components are replaced and the steps 406-408 are repeated until all the critical components are operating properly. If it is determined that all the critical components are operating and that all the appropriate connections are made in the step 407, then in the step 409 the file server periodically updates and reconfigures each of the components to ensure the components have appropriate and updated functionalities.

According to the preferred embodiment of the invention, the file server is periodically updated with new configuration files and software from a remote location and the updated configuration files and software are then used to periodically update each of the system components. In this way the file server provide an “intelligence link” to each of the components from a remote location. An update of a component is preferably initiated at the request of the component. Accordingly, each of the system component periodically requests the file server to perform an update with the appropriate configuration file and updated software, preferably when the requesting component is experiencing a low work load or is idle

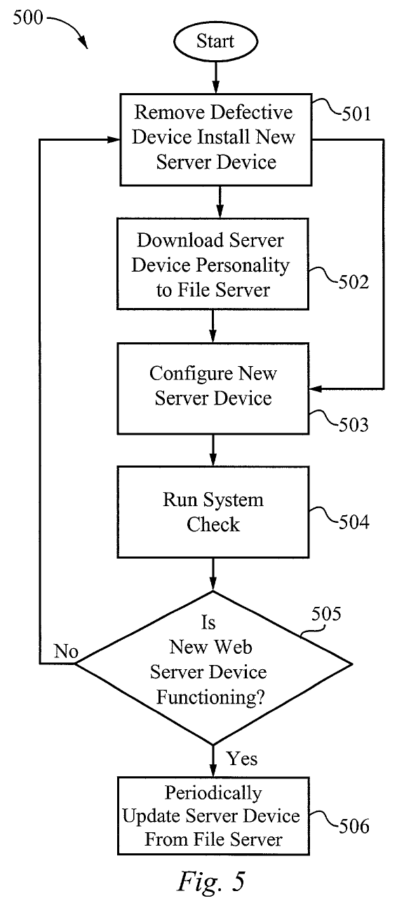

FIG. 5 illustrates a block flow diagram for exchanging or replacing a server within the web support system described above. In the step 501, the malfunctioning component is remove from the pre-configured wire harness and replaced with a new component. Once the replacement device is installed and connected to the pre-configured wire harness in the step 501, then in the step 503 the replacement device is programmed with a configuration file from the file server. Generally, the configuration file will program the new device with the same functional personality as the device replaced in the step 501. It is often the case, however, that the replacement device performs a new or modified function within the system and, therefore, the configuration file corresponding functionality of the replaced device is not suitable or compatible for the new device. In this case, and other cases where a new configuration file is required, a new configuration file is down loaded to the file server in the step 502, and prior to the step 503 of programing the new device. Preferably, the new configuration file, corresponding to the modified personality, is down-loaded to the file server in the step 502 from a remote location as previously described above.

After the new server is programed with the appropriate configuration file in the step 503, then in the step 504 a system check is performed to ensure that the new device is operating correctly. If it is determine that the replacement device is operating correctly in the step 505, then in the step 506 the device is periodically updated with a configuration file(s) and software as previously described. If, however, it is determined that the replacement device is not operating correctly in the step 505, then the steps 501-505 are repeated as necessary.

Because each server component within a system is typically provided in duplicate, a malfunction of a single server device will not cause a catastrophic system failure. However, a web site operating with a only a single critical server runs a significant chance of a catastrophic systems failure. FIG. 5 outlines a method for replacing a defective server device when a replacement server device is available. However, there are circumstances when a spare or a replacement server is not available. To reduce the risk of a catastrophic system failure, it is useful to have a method and mechanism for replacing a critical malfunctioning servers with a “non-critical” or “less critical servers” which are available in duplicate within the system. In this way the web system is capable of maximizing available system resources to support critical system functions. Preferable, such a method allows for the replacement of a defective web server within the system with a functioning application server within the system.

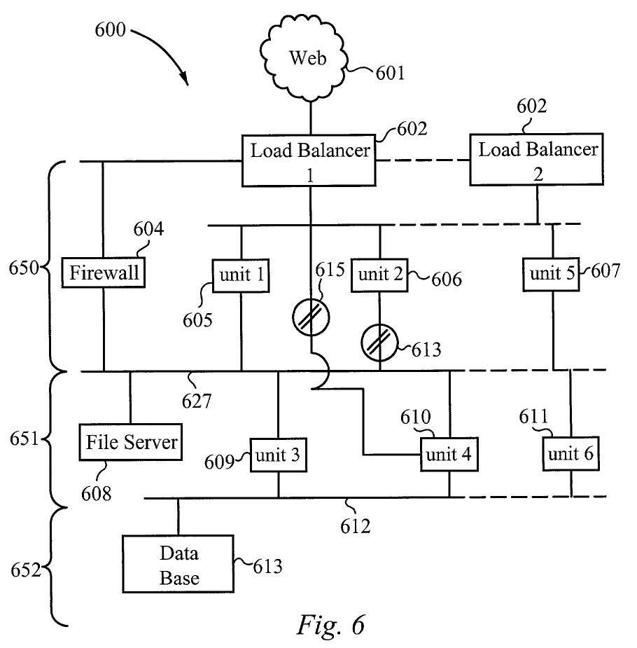

The FIG. 6 illustrates schematic of a three-tier web-support system architecture with a wire harness configured with a switching means for exchanging the connectivities of server devices within the system 600. The system 600 has web interface tier 650 with servers 605-607. The web interface tier 650 is connected to the web 601 at the systems level through a bus 627 with an in-line router device or a firewall device 604. The system architecture preferably is a multi-path data transmission architecture described in detail above and illustrated in the FIG. 3, but may also be a single path data transmission architecture. The system 600 has a load balancer 602 which coordinates data transmissions and directs traffic between customers accessing web pages or HTML files stored on the units 605-607.

Still referring to FIG. 6, the system 600 also has an application tier 651 with the server units 609-611. The data base tier 652 has at least one data base device 613 which provides the data storage and data management required for the system. The units 605-607, in the web interface tier 650, and the units 609-611, in the application tier 651, are in duplicate (not shown) and are connectably interchangeable with one another as hardware devices. Further, each of the units 605-611 are capable of being programmed to operate as an application server or as a web server. For example, the unit 610 can be physically interchanged with the unit 606 by disconnecting the two units from the wire harness and reconnecting the unit 606 to the original connectivities of the unit 610 and connecting the unit 610 to the original connectivities of the unit 606. The unit 606 can then be programmed to operated as a application server and the unit 610 can be programed to operate as a web server.

Still referring to FIG. 6, the wire harness 612 has a switching meaning, indicated by the stitches 613 and 615, for the changing the connectivities of at least one of the server units with the connectivities of another server unit; in this case switching unit 606 for unit 610. Typically, the web server units 605-607 are more critical to the operations of the system 600 than are the applications servers 609-611. Therefore, it is preferable that the wire harness 612 is configured to switch out at least one application server from the application tier 651 to the web interface tier 650. It is clear, however, that the wire harness may be configured to “switch out” any of the units 605-611 with any other of the units 609-611 in order to maintain redundancy of the system components that are considered to be most critical to the operation of the system 600.

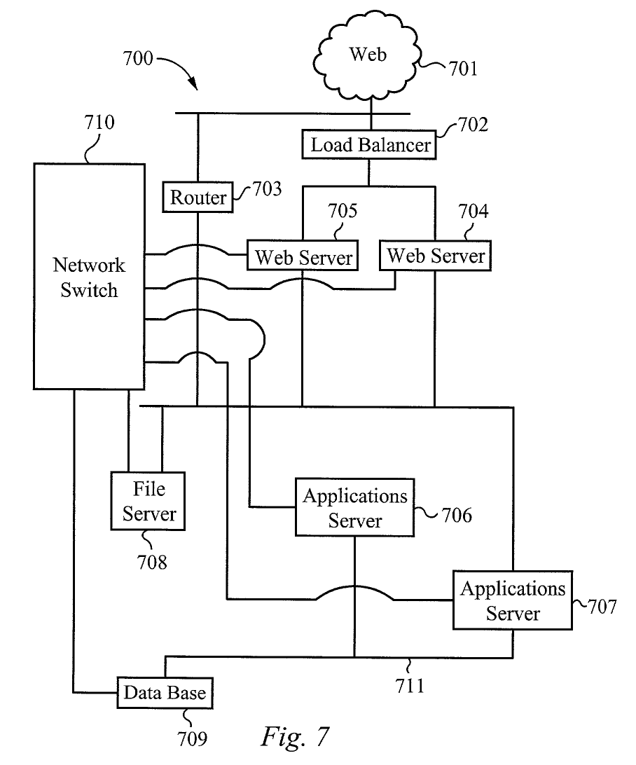

FIG. 7 illustrates web support system architecture 700 with a central control unit 710 according to an alternative embodiment of the current invention. The web support system 700 has a load balancer 702, a router 703, web servers 704-705, application servers 706-707, a file server 708 and a data base device 709 for providing systems functions previously described. Preferably, each of the web servers 704-705, the application servers 706-707, the file server 708 and the data base 709 are in communication with the central control unit 710. The control unit 710 has data processing and data storage capabilities. The central control unit 710 is in communication with the components 704-709 by any suitable means including video cameras, temperature sensors, mechanical sensors and the like. The central control unit 710 servers two primary functions. Firstly, central control unit 710 tracks the physical environment of each of the system components 704-709. When the physical environment of a component compromises the performance of that component, the control unit 710 generates a warning or an alert to warn an operator that the component is in jeopardy of a failure. Secondly, the control unit 710 stores tracking data collected while monitoring the physical environments of each of the components 704-709. In the event that a failure does occur, tracking data can be used to determine the cause of the failure and to implement procedures to prevent the reoccurrence of such a failure.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention. Specifically, it will be apparent to one of ordinary skill in the art that the device of the present invention could be implemented in several different ways and the architecture, system and method disclosed above are only illustrative of preferred embodiments of the invention.

1. A web server architecture comprising a web interface for providing a plurality of data transmission paths to the web, wherein at least one of the plurality of data transmission paths is an unrestricted data transmission path and wherein at least one of the plurality of transmission paths is a restricted data transmission path.

2. The web server architecture of claim 1, wherein the restricted data transmission path comprises a fire wall device for preventing the transmission of unauthorized data.

3. The web server architecture of claim 1, wherein the web server interface discriminates sensitive data and routes the data to the restricted data transmission path.

4. The web server architecture of claim 1, wherein the web interface comprises a plurality of web servers couple together through a local bus network.

5. The web server architecture of claim 4, further comprising a file server, at least one application server and a data base couple to each other and the plurality of web servers through the local bus network.

6. The web server architecture of the claim 5, further comprising a control box couple to each of the plurality of web server, the file server, the at least one application server, and the data base for monitoring their physical condition.

7. The web server architecture of claim 5, wherein local bus network comprises a pre-configured wire harness for providing physical connectivities of each of the plurality of web servers, the file server, the at least one application server and the data base to the local bus network.

8. The web server architecture of claim 7, wherein the preconfigured wire harness comprises a switch for switching the connectivities of the at least one application server with the connectivities of one of the plurality of web servers.

9. The web server architecture of claim 5, wherein the file server stores configuration files for programing each of the plurality of web servers, the at least one application server and the data base.

10. The web server architecture of claim 9, wherein the file server automatically and periodically programs each of the plurality of web servers and the at least one application server to perform.

11. An method for building a web server support system comprising the steps of:
a. providing a network bus configured to support data transmissions between system components and a files server;
b. downloading configuration files corresponding to each type of system component in to the file server; and
c. transmitting the configuration file corresponding to each type of system component, wherein transmitting the configuration file corresponding to each type of system component programs each component to perform a predetermined function.

12. The method of claim 11, wherein the step of downloading configuration files corresponding to each type of system component into the file server is initiated from a remote location and over the web.

13. The method of claim 12, wherein the step of transmitting the configuration file corresponding to each type of system component is initiated by each type of system component.

14. A method of efficient transmitting data between the web and a web server network having a plurality of web servers, the method comprising the steps
a. discerning sensitive data and non-sensitive data;
b. routing non-sensitive data through a non-restricted pathway between the web and the web server network; and
c. routing sensitive data through a restricted pathway between the web and the web server network, wherein the restricted pathway comprises a firewall device.

15. An auto-programing web support system -for supporting a web site, the system comprising:
a. a plurality of web servers;
b. a plurality of application servers;
c. a file server for storing configuration files from programing the plurality of web servers and the plurality of application servers;
d. a data base;
e. a system network for providing the connectivities between the file server, the web servers, the application servers and the data base and for transmitting the configuration files from the file server to the web servers and the application servers, wherein transmitting the configuration files from the file server to the web servers and the application servers programs the web servers and the application servers; and
f. a connection means for connecting the web servers to the web and through which data is transmitted between the web servers and the web.

16. The system of claim 15, wherein the system network includes a wire harness providing predetermined connectivities for each of the web servers and application servers.

17. The system of claim 15, wherein each of the web servers and application servers is programed according to a predetermined function with as determined by the server's serial number.

18. The system of claim 15 wherein the configuration files are down loaded to the file server over the web from a remote location.

19. The system of claim 15, wherein the system further includes a control unit that monitors the physical condition of the web servers and application servers.

20. The system of the claim 19, wherein the control unit initiates an alarm in the event that the physical condition any one web servers and application servers jeopardizes its functionality.

21. The method of the claim 14, further comprising connection means for connecting the system to-the web comprises a plurality of data transmission pathways for transmitting data between the system and the web.

22. The method of claim 21, wherein one of the transmission pathways comprises a firewall.

23. The method of the claim 21, discriminating sensitive data and routing the sensitive data to the transmission pathways comprising the firewall.
